(19) United States
(12) Patent Application Publication
(10) Pub. No.: US 2024/0336232 A1
(43) Pub. Date: Oct. 10, 2024

(54) VEHICLE ROOF MODULE FOR A SENSOR

(71) Applicant: INALFA ROOF SYSTEMS GROUP B.V., Oostrum (NL)

(72) Inventor: Thomas Anton Martijnszoon Albers, Venray (NL)

(21) Appl. No.: 18/624,799

(22) Filed: Apr. 2, 2024

(30) Foreign Application Priority Data
Apr. 5, 2023 (EP) 23166824.5

(51) Int. Cl. B60S 1/56; B60R 11/00; B62D 25/06; G01S 7/481; G01S 7/497; G01S 17/931

(52) U.S. Cl. CPC B60S 1/566; B60R 11/00; B62D 25/06; B60R 2011/004; G01S 7/4813; G01S 2007/4977; G01S 17/931

(57) ABSTRACT

The disclosure relates to a vehicle roof module for a sensor. The roof module including a wiper assembly with wiper blade carried on a wiper arm, a sensor housing with a visor having a view portion and park portion, a guide defining a wiping path and a parking path, and a slide configured for sliding the wiper assembly over the guide along the wiping path and the parking path. When sliding the wiper assembly over the wiping path the wiper arm slides along the sensor housing such that the wiper blade wipes the view portion of the visor. And when sliding the wiper assembly over the parking path the wiper arm slides along the sensor housing such that the wiper blade is moved over the park portion of the visor.

### CROSS-REFERENCE TO RELATED APPLICATION

The present application is based on and claims the benefit of European patent application Serial No. 23166824.5, filed Apr. 5, 2023, the content of which is hereby incorporated by reference in its entirety.

### BACKGROUND

The discussion below is merely provided for general background information and is not intended to be used as an aid in determining the scope of the claimed subject matter.

Aspects of the invention relate to a vehicle roof module for a sensor such as a LiDAR sensor or other light sensitive sensor. In particular, aspects of the invention relate to a cleaning assembly for a screen of a housing enclosing such a sensor.

In support of driving assistance for vehicles and for the further aim of autonomous driving of vehicles, sensors for image recognition, for example of road and traffic signs, are being mounted on such vehicles. Thereto, the sensor may be placed within a sensor housing on top of the roof of a vehicle to provide a wide field of view. The sensor housing will have a front screen or visor to provide a light sensitive sensor, such as a LiDAR sensor, with an unobstructed field of view. As with any other vehicle screen or visor, such as head lights or front wind shield, dirt and dust may accumulate over time on the screen. In order to ensure proper operation and maintain a clear field of view, the screen or visor may need to be cleaned over time. Though wipers may be applied with such screens, a problem therewith is that these could interfere with the field of view of the sensor.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

When not used to wipe the visor of the sensor housing, the wiper is preferably in a position that allows for a clear field of view of the sensor. In addition, the wiper is preferably in a position that does not extend beyond the sensor housing. As this may either result in wind noise, in the wiper accumulating dirt and dust, and/or leaves the wiper being prone to fracture or tampering. In particular, the wiper blade or lip of the wiper blade may be prone to wear and tear. Accordingly, it is preferred to shield the wiper when not in use in order to prolong the lifetime and preserve proper functioning of the wiper.

As an aspect of the invention there is provided a vehicle roof module with a sensor housing that takes in account the above preferences. The vehicle roof module includes a wiper assembly with a wiper blade on a wiper arm and a sensor housing with a visor having a view portion and a park portion. The vehicle roof module further includes a guide defining a wiping path and a parking path, and a slide configured to slide the wiper assembly over the guide along the wiping path and the parking path. When sliding the wiper assembly over the wiping path the wiper arm slides along the sensor housing such that the wiper blade wipes the view portion of the visor. And when sliding the wiper assembly over the parking path the wiper arm slides along the sensor housing such that the wiper blade is moved over the park portion of the visor.

As the material of the blade of the wiper, such as e.g. rubber, will be tensioned against the visor, moving the wiper to a resting or parking position is preferably done over a smooth surface, such that the wiper blade lip is prevented from grating or scraping against over an edge of the visor or over a transition of material between visor and sensor housing.

Accordingly, the inventors have a found it advantageously to have the surface of the visor to extend beyond the functional surface required for the field of view of the sensor i.e. sensor visibility. This to provide an extended parking surface for a wiper assembly. Taking advantage of this surface requires a kinematic assembly that parks the wiper assembly in that parking portion of the visor.

Further objects, aspects, effects and details of particular embodiments of the invention are described in the following detailed description of a number of exemplary embodiments, with reference to the drawings.

### BRIEF DESCRIPTION OF THE DRAWINGS

By way of example only, the embodiments of the present disclosure will be described with reference to the accompanying drawing, wherein:

FIG. 1 illustrates a perspective view of a vehicle roof with an example of a vehicle roof module;

FIG. 2 illustrates the vehicle roof module of FIG. 1 in more detail;

FIG. 3 illustrates in cross-section vehicle roof module of FIG. 1;

FIG. 4 is an exploded view of the roof module of FIG. 1;

FIG. 5 illustrates in cross-section an alternative example of a vehicle roof module;

FIGS. 6A-D illustrates an example of locator pin curve;

FIGS. 7A-E illustrate another example of locator pin curve; and

FIGS. 8A-G illustrates yet another example of locator pin curve.

### DETAILED DESCRIPTION OF ILLUSTRATIVE EMBODIMENTS

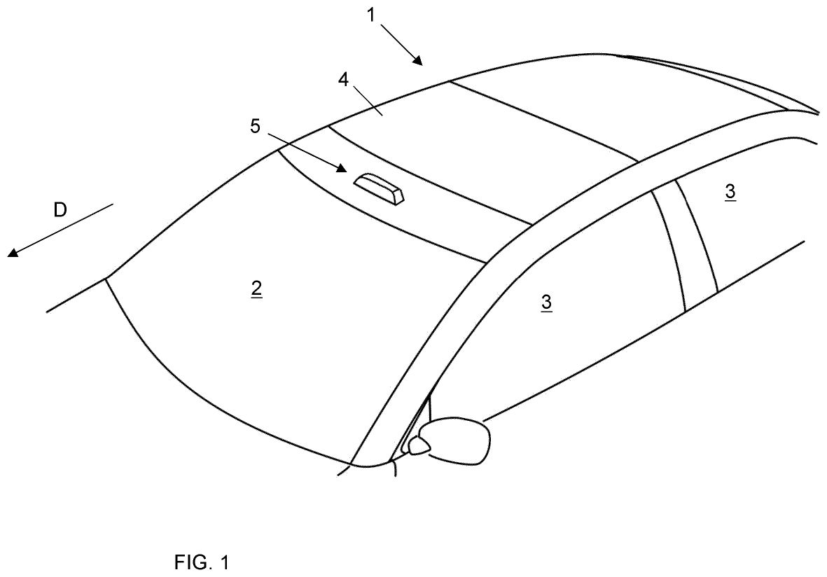

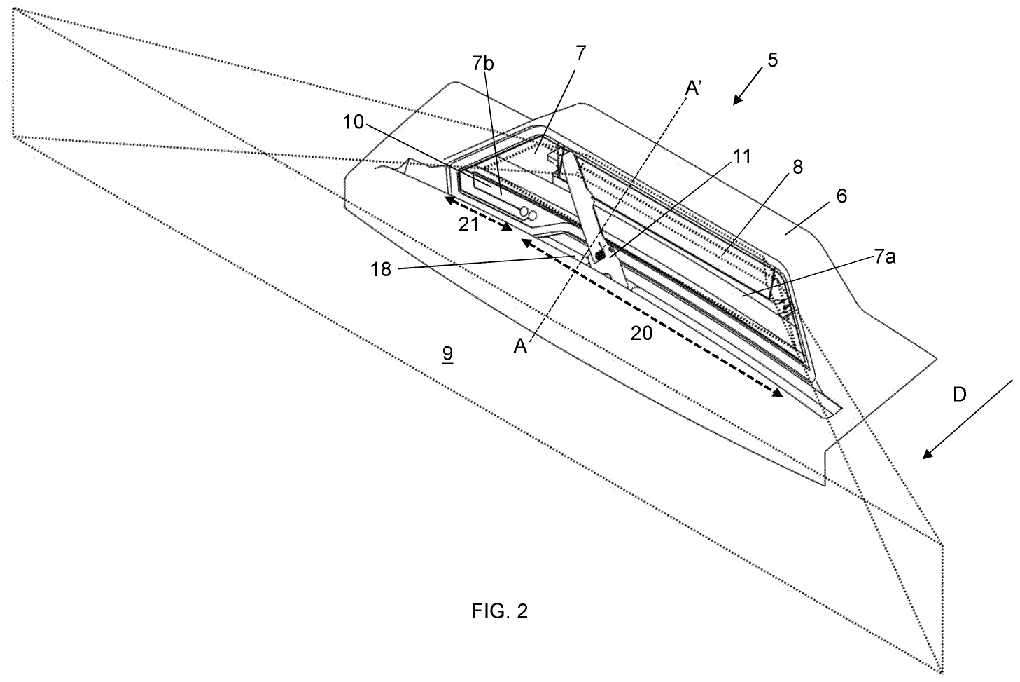

Referring to FIG. 1, a perspective view of an example of a vehicle roof 1 is schematically illustrated. Further shown are vehicle front window 2, side windows 3 and an optional roof window 4. On top of the vehicle roof 1 a vehicle roof module 5 is shown, also referred to as an external sensor module, in this example the module 5 encloses light sensitive sensor herein embodied as a LiDAR sensor.

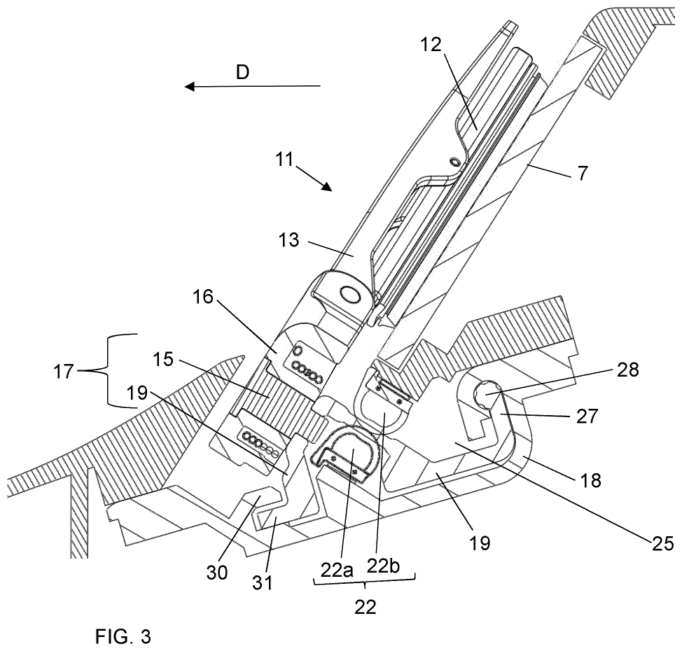

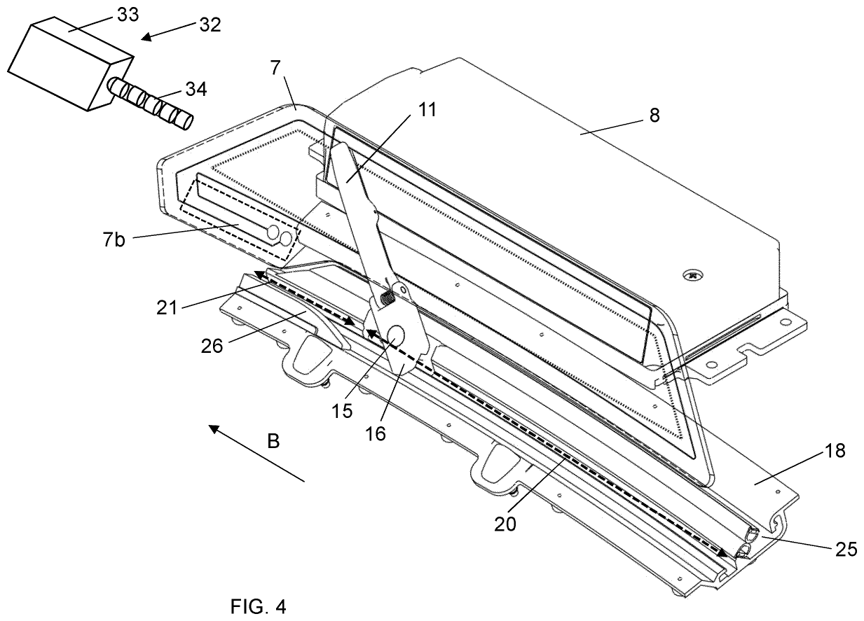

Referring to FIG. 2, the vehicle roof module 5 of FIG. 1 is shown in more detail. The module 5 includes a sensor housing 6 having a visor or screen 7 provided at a front side of the housing with reference to a forward driving movement of a vehicle, indicated by arrow D. The visor 7 has a view portion 7a and a park portion 7b. The sensor housing 6 encloses a sensor 8 which has a field of view 9 that is aligned with the view portion 7a of the visor 7, which alignment ensures that objects within the field of view 9 may be detected by the sensor 8. The park portion of the visor 7 provides a resting position 10 for a wiper assembly 11, an example of which is shown in more detail in FIG. 3. The wiper assembly may include a wiper blade and a wiper arm. In order to prevent the wiper blade from freezing due to frost, the park portion and/or resting position may be provided with heating circuitry or heat conductor.

The roof module 5 further includes a guide 18, in this embodiment running in front of the housing 6 adjacent to the visor 7. The guide 18 defines a wiping path 20 and a parking path 21. The roof module further includes a slide 17, such as seen in detail in FIG. 2, is configured for sliding the wiper assembly 11 over the guide 18 along the wiping path 20 and the parking path 21. When sliding the wiper assembly 11 over the wiping path 20 the wiper arm 13 slides along the sensor housing 6 such that the wiper blade 12 wipes at least the view portion of the visor 7. When sliding the wiper assembly 11 over the parking path 21 the wiper arm 13 slides along the sensor housing 6 such that the wiper blade 12 is moved over the park portion of the visor 7. Seen from the front, the park portion 7b of the visor will preferably be below the view portion 7a of the visor, such that when the wiper assembly 11 is parked there it will be hidden within the roof module and alleviate aerodynamic interference. Thereto, the guide 18 of the roof module may be recessed relative to the roof 1. Instead, or in addition, a wind deflector may be placed in front of the sensor housing 6. The wind deflector may be part of the roof module or be an integrated part of the guide 18. In each of the proposed embodiments, the wind deflector will be positioned such that the sensor 8 is provided with a clear field of view 9.

Furthermore, sliding along the parking path 21 slides the wiper assembly 11 between a parking position in the parking path 21 and an operational position in the wiping path 20. In the parking position the wiper blade 12 engages the park portion 7b of the visor 7. And in the operating position the wiper blade 12 engages the view portion 7a of the visor 7. In order to drain water from the roof module, for example water collected by the wiper assembly and/or accumulated in the guide, the guide may be connected to drain channels from the vehicle body, as for example by tubing or ducts.

FIG. 3 shows a cross-section of the roof module of FIG. 1 along line dotted line A-A′. The cross-section illustrates the wiper assembly 11, a slide 17, the visor 7 and the guide 18. The wiper assembly 11 includes the wiper blade 12 that is mounted on the wiper arm 13. In this example, the wiper arm 13 is hingeably mounted on a base 16. The slide 17 includes a driven slider 19 whereon a rod 15 is mounted. The rod 15 is configured to pivotally carry the base 16 of the wiper assembly 11. Thus, the rod 15 defines a pivot joint 15′. In some embodiments, the base may form an integral part of the wiper arm. In other embodiments, the base may form an integral part of the rod.

The guide 18 has a slider channel 25 for guiding the driven slider 19 parallel to the visor 7 of the sensor housing 6. The wiper assembly 11 may further include tensioning means for tensioning the wiper blade, or at least the lip of the wiper blade, against the visor 7 in the operating position. The tensioning means may be a torsion spring, coil spring, elastomeric material or other suitable means providing a bias force to return to a default position after being moved out thereof.

As can be seen in FIG. 3, the roof module further includes a seal 22 for sealing a gap between the visor 7 and the guide 18. In this example, the seal consists of two touching ribs 22a, 22b. Between these ribs 22a, 22b the driven slider 19 protrudes from one side through the seal 22 to another side. In other examples, it may be that only the rod protrudes from the driven slider on one, inner, side of the seal through the seal and such that the base may pivot at the other, outer side of the seal and carry the wiper assembly. The guide channel 18 is shaped such that when the roof module is mounted on a vehicle roof the bottom of the guide is inclined when viewed from the front. This results in that the mechanics and electronics of the module inside the housing are raised relative to the outer portion of the guide 18. Accordingly, the lower outer portion of the guide may function as water drainage, while ensuring that the upper portion remains clear from any fluid that might be passing through the seal.

Referring to FIG. 4, an exploded view of the roof module of FIG. 1 illustrates the guide 18, the sensor 8, the visor 7, the wiper assembly 11 and the wiping path 20 and parking path 21. The slide is configured for sliding the wiper assembly 11 over the wiping path 20, indicated by dotted line in FIG. 4. The guide 18 and the slide are configured such that when sliding the wiper assemblyl1 over the wiping path 20 the wiper arm 13 slides along the sensor housing 6 such that the wiper blade 12 may wipe the visor 7. The guide 18 and the slide 17 are further configured such that when sliding the wiper assembly 11 over the parking path 21 the wiper arm 13 slides along the sensor housing 6 such that the wiper blade 12 is moved over the park portion 7b of the visor 7.

The guide 18 further includes a locator, in the embodiment of FIG. 4 embodied as a locator cam 26 positioned in the parking path 21. The locator is configured to pivot the wiper assembly 11 into a parking position by acting on the base 16 when the driven slider 19 is moved in the slider channel 25 along the parking path 2. When moved in the direction of the park portion 7b of the visor 7, as indicated by arrow B, the wiper assembly 11 will pivot to a collapsed, here substantially horizontal, position. When one outer end of the base 16 hits the locator cam 26, the base 16 will pivot around pivot joint 15′ when the driven slider 19 is moved further to the side. The shape of the locator cam 26 is chosen such that the base 16 and wiper assembly 11 mounted thereon will pivot until the wiper assembly 11 is in the, here horizontal, parking position.

Vice versa, when the driven slider 19 moves away from the park portion 7b, the shape of the locator cam 26 will ensure that the base and therewith wiper assembly is allowed to take a, here vertical, operation position again.

In the embodiment of FIG. 4, the locator cam and base are aligned to move relative to each other within a same plane, meaning that movement of the wiper assembly towards the cam will result in direct contact. In some embodiments, the base may be provided with contact means as e.g. a pin or other protruding part. Furthermore, in FIG. 4, the locator cam is positioned at a height relatively below the pivot point and acts on a lower end of the base or part thereof. In other embodiments, the locator cam may be positioned at a height relatively above the pivot point and act upon a high end of the base or part thereof. Depending on where the locator cam acts upon, low end or high end, the wiper assembly will either pivot to one side or the other.

As will be understood, the pivoting of the wiper arm about the pivot point is controlled by the arrangement of the wiper assembly. The orientation of the wiper arm with regard to the visor may be arranged to take any desired angle, depending on the application and, for example, may be set to run parallel to a side end of the visor.

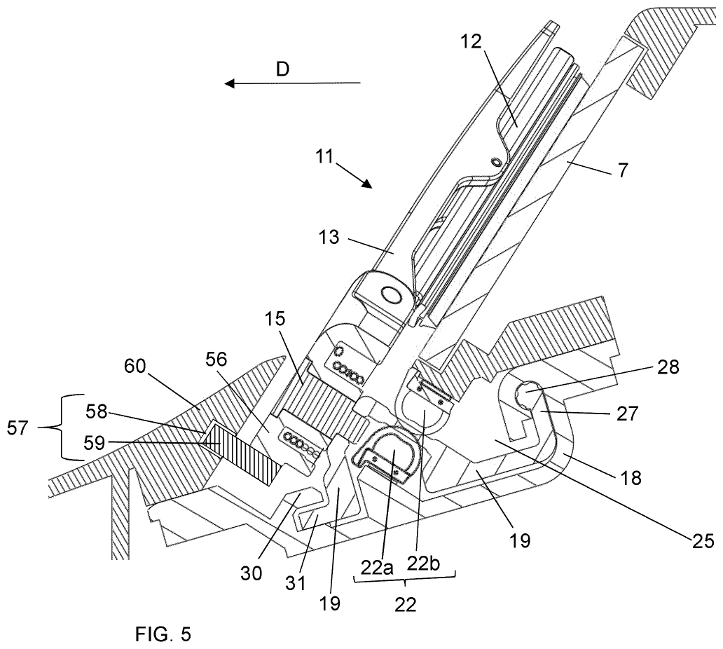

Referring to FIG. 5, a cross-section of another example of a roof module is shown. In this example, the roof module differs from the embodiment of FIG. 4 in that the locator 57 includes a locator curve 58 and corresponding locator pin 59. The locator curve 58 is embedded in a front side panel 60 of the guide 18. The front side panel may be a wind deflector or a part thereof. The locator pin 59 protrudes from the base 56 of the wiper assembly 11 towards an opposing side of the front side panel 60 and into the locator curve 58. The locator curve 58 may include a wiping portion 58a and a parking portion 58b.

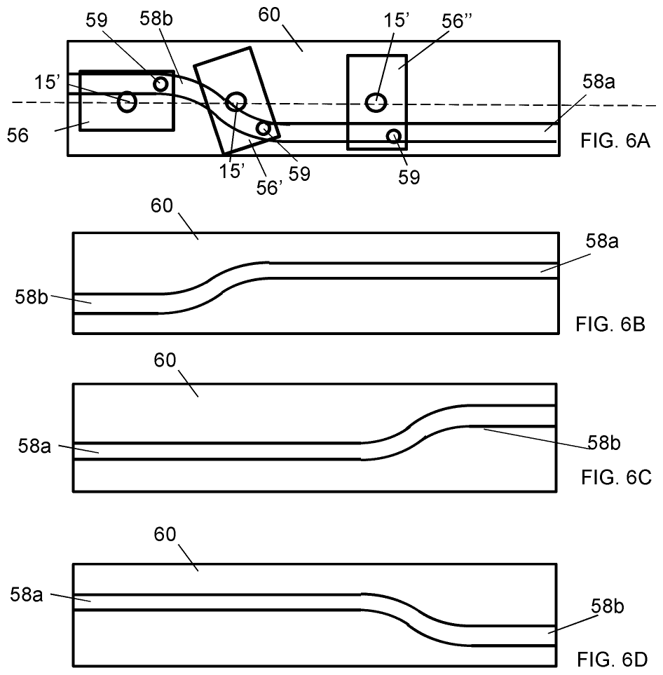

Referring to FIG. 6A, an example of the shape of the locator curve 58 is illustrated. The locator curve provides a kinematic movement for the wiper assembly that is similar to that of locator cam 26 of FIG. 4. When the driven slider 19 is moved through the channel 25 along the wiping path 20 and the parking path 21, the locator pin 59 will travel through the wiping portion 58a and the parking portion 58b of the locator curve 58. When the pin 59 travels through an S-portion of the curve 58, the wiper assembly is pivoted about the pivot joint 15′ of the rod 15. The S-curve portion determines a transition between the wiping portion 58a and the parking portion 58b. The movement and rotation of the base 56 is illustrated in FIG. 6A by consecutive positions of the base 56, 56′and 56″, moving from left to right.

As will be understood, the travelling of the locator pin 59 through the wiping portion 58a corresponds with the sliding of the wiper assembly 11 over the wiping path 20 and the travelling of the locator pin 59 through the parking portion 58b corresponds with the sliding of the wiper assembly 11 over the parking path 21. The location of the pin 59 is with an offset with regard to pivot point 15′. The offset will determine the manner of rotation and angle at which the base 56 will be.

Referring to FIGS. 6B-D, various alternative examples of locator curves 58 are illustrated. Depending on the position of the locator pin on the base, relatively above or below the pivot joint, the wiper assembly will pivot in one direction or another. Further means for limiting the freedom of rotation of the wiper assembly in a desired direction may be arranged on the base to provide a locking or blocking stop.

Referring to FIGS. 3 and 5, the slider channel 25 may have a profile, in cross-section, with a recessed slide portion 28 extending in a longitudinal direction of the channel. As can be seen in the cross-sections, the recessed slide portion 28 is also perpendicular to the longitudinal plane of the slider channel 25. The slider 19, in these embodiments, further includes a raised wall or flange 27 that is intended to cooperate with the recessed portion 28 and to slide therethrough when the driven slider is moved through the channel. The flange 27 protrudes perpendicular from a main body of the driven slider 19. The co-operative configuration of recessed portion 28 and flange 27 may prevent the driven slider 19 from skewing within the channel 25. In addition, the guide may be provided with a flange portion 30 configured protruding over a lip 31 of the driven slider 19, as is shown in FIGS. 3 and 5.

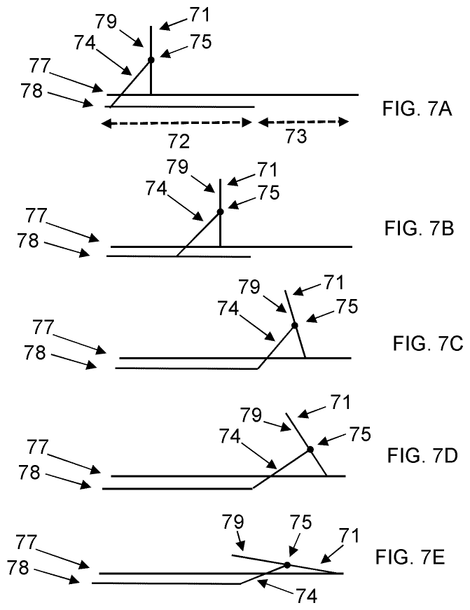

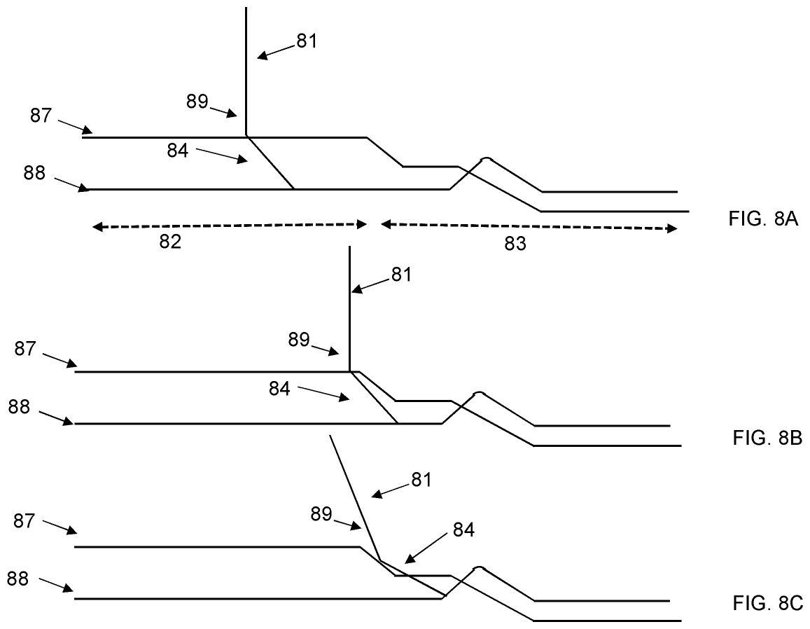

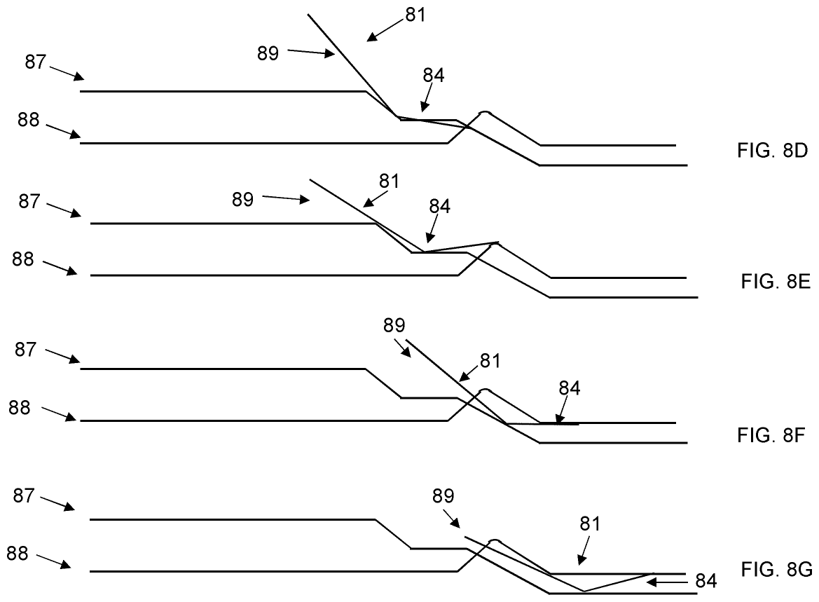

Referring to FIGS. 7 and 8, further alternative examples of locator curves are schematically illustrated. FIGS. 7A-E illustrate subsequent positions of the same wiper assembly 71 sliding from left to right along the wiping path 72 and the parking path 73. Hence, the parking position is on the right side. In this embodiment, the locator curve includes two locator tracks 77, 78. A first locator track 78 guides a locator pin of a wiper leg 74 and a second locator track guides a locator pin of a wiper arm 79. From an initial position in FIG. 7A, when sliding the wiper assembly 71 to the right, both the wiper leg 74 and wiper arm 79 will move accordingly. In FIG. 7C, the wiper leg 74 will be halted at a lower end, and cause the wiper arm 79 to pivot about pivot joint 75. When the wiper assembly 71 slides further, this will result in the wiper arm 79 collapsing further downwards, see FIG. 7D, until the wiper arm 79 reaches a final parking position at the park portion of the visor 7, see FIG. 7E. Again, the movement of the wiper assembly 71 may be arranged by a slide that includes a driven slider that is moved along a guide.

Referring to FIGS. 8A-G, the kinematic movement of another embodiment of a slide with locator curve for a vehicle roof module are illustrated subsequently. The locator curve again includes two locator tracks 87, 88. The wiper assembly 81 slides, with subsequent position illustrated in FIGS. 8A-8G, from left to right along the wiping path 82 and the parking path 83. Hence, the parking position is again on the right side. The wiper assembly 81 includes a wiper leg 84 and a wiper arm 89.

From an initial position in FIG. 8A, when sliding the wiper assembly 81 to the right, both the wiper leg 84 and wiper arm 89 will move accordingly, FIG. 8B. As seen in FIG. 8C, the wiper leg 84 will trail ahead of the wiper arm 89, which due to the elaborate S-curve will be lowered. When the wiper assembly 81 slides further, this will result in the wiper arm 89 collapsing further downwards, see FIG. 8D, while the wiper leg 84 will be lifted by the locator track 88. When the wiper arm 89 is in a desired position, sufficient to be parked as in FIG. 8E, the wiper arm 89 and wiper leg 84 move further downward together, FIG. 8F until the wiper assembly reaches the final parking position at the park portion of the visor 7, see FIG. 8G. Again, the movement of the wiper assembly 81 may be arranged by a slide that includes a driven slider that is moved along a guide.

In each of the embodiments described, the roof module may further include a drive assembly 32, as e.g. shown in FIG. 4, configured for driving the driven slider 19 back and forth through the slider channel 25 of the guide 18. Thereto, the drive assembly 32 may include a motor 33 and a drive cable 34, the motor being arranged for operating the driven slider 19 by means of the drive cable 34. The motor may be any kind of electric motor capable of pulling and pushing the drive cable 34 in either direction. To further control movement of the drive cable, for example to prevent coiling or convolving thereof, the drive cable may be fed through a rigid sleeve or gutter. Accordingly, the slider channel 25 may be provided with such a gutter. In the embodiment of FIGS. 3 and 5, the recessed slide portion 28 extending longitudinally within the slider channel 25 may function as drive cable gutter.

Although the present invention has been described with reference to preferred embodiments, workers skilled in the art will recognize that changes may be made in form and detail without departing from the spirit and scope of the invention.

Furthermore, although exemplary embodiments have been described above in some exemplary combination of components and/or functions, it should be appreciated that, alternative embodiments may be provided by different combinations of members and/or functions without departing from the scope of the present disclosure. In addition, it is specifically contemplated that a particular feature described, either individually or as part of an embodiment, can be combined with other individually described features, or parts of other embodiments.

What is claimed is:

1. A vehicle roof module for a sensor, comprising:
a wiper assembly comprising a wiper blade carried on a wiper arm;
a sensor housing comprising a visor, the visor comprising a view portion and park portion;
a guide defining a wiping path and a parking path; and
a slide configured to slide the wiper assembly over the guide along the wiping path and the parking path,
wherein the wiper arm slides along the sensor housing such that the wiper blade wipes the view portion of the visor, and
wherein the wiper arm slides along the sensor housing such that the wiper blade is moved over the park portion of the visor.

2. The vehicle roof module according claim 1,
wherein the wiper assembly slides along the parking path between a parking position in the parking path and an operational position in the wiping path;
wherein in the parking position the wiper blade engages the park portion of the visor; and
in the operating position the wiper blade engages the view portion of the visor.

3. The vehicle roof module according to claim 2, wherein
the slide comprises:
a driven slider comprising a rod configured to pivotally carry a base, wherein the base is configured to carry the wiper assembly; and
the guide comprises:
a slider channel configured to guide the driven slider parallel to the visor of the sensor housing.

4. The vehicle roof module according to claim 3, wherein the guide further comprises:
a locator configured to pivot the wiper assembly in the parking position by acting on the base when the driven slider is moved in the slider channel along the parking path towards the park portion.

5. The vehicle roof module according to claim 4, wherein the locator comprises at least one locator cam.

6. The vehicle roof module according to claim 4, wherein
the locator comprises:
at least one locator pin arranged on the base; and
at least one locator curve comprising a wiping portion and a parking portion.

7. The vehicle roof module according to claim 6,
wherein, when moving the driven slider in the slider channel along the wiping path, the at least one locator pin slides in the wiping portion of the at least one locator curve; and
wherein, when moving the driven slider in the slider channel along the parking path, the at least one locator pin slides in the parking portion of the at least one locator curve.

8. The vehicle roof module according to claim 6, wherein the guide further comprises a front side panel running parallel to the visor, wherein the front side panel comprises the locator curve.

9. The vehicle roof module according to claim 8, wherein the front side panel comprises a wind deflector.

10. The vehicle roof module according to claim 3, further comprising a seal configured to seal a gap between the sensor housing and the guide; and
wherein the driven slider and/or the rod of the driven slider protrudes through the seal.

11. The vehicle roof module according to claim 3, wherein the slider channel comprises a recessed slide portion; and
the driven slider comprises a flange corresponding to the recessed slide portion.

12. The vehicle roof module according to claim 1, further comprising a sensor in the sensor housing.

13. The vehicle roof module according to claim 3, further comprising a drive assembly configured to drive the driven slider through the guide.

14. The vehicle roof module according to claim 13, wherein the drive assembly comprises a motor and a drive cable, the drive cable connecting the driven slider to the motor.

15. The vehicle roof module according to claim 14, wherein the slider channel comprises a drive cable gutter for the drive cable.

16. The vehicle roof module according to claim 15, wherein the slider channel comprises a recessed slide portion, wherein the driven slider comprises a flange corresponding to the recessed slide portion, and wherein the recessed slide portion of the slider channel comprises the drive cable gutter for the drive cable.
